(19) United States
(12) Patent Application Publication
(10) Pub. No.: US 2024/0170238 A1
(43) Pub. Date: May 23, 2024

(54) BIDIRECTIONAL SWITCH STRUCTURE AND TACTICAL LIGHT

(71) Applicant: Olight Group Co.,Ltd, GUANGDONG (CN)

(72) Inventors: Boru FANG, GUANGDONG (CN); Shuze WU, SHENZHEN CITY (CN)

(21) Appl. No.: 18/427,826

(22) Filed: Jan. 31, 2024

(30) Foreign Application Priority Data
Dec. 4, 2023 (CN) 2023116518310

(51) Int. Cl. H01H 15/10; F21V 23/04; H01H 9/04

(52) U.S. Cl. CPC H01H 15/10; F21V 23/0421; H01H 9/04

(57) ABSTRACT

A bidirectional switch structure having a base, a switch arranged on a side surface of the base, a rotating shaft connected to the side surface of the base and rotatable around its own axis, a button hinged to the rotating shaft, and a protruding piece arranged at an inner side of the button close to the switch. When the button is pressed down, the button rotates around the rotating shaft and presses the switch through the protruding piece; when the button is pressed laterally, the button rotates at a hinged position where the button is hinged to the rotating shaft around an axis perpendicular to the rotating shaft and presses the switch. The invention can achieve lighting control by triggering the switch by means of lateral-pressing or down-pressing of the button, and has the advantages of being simple in structure, easy to assemble, and low in production cost.

### BACKGROUND OF THE INVENTION

The present invention belongs to the technical field of tactical lighting equipment, and particularly relates to a bidirectional switch structure and a tactical light.

A tactical light is mobile lighting equipment which is mounted on a tactical weapon for lighting, and a switch button of the tactical light is generally arranged at a tail end. A switch is controlled by performing operations such as lateral-pressing, down-pressing, and the like on the button. Common tactical lights on the market generally can only achieve one of the switch operation modes. Every time when the tactical light is replaced, since all manufacturers have different switch designs, the user needs to get used to the switch operations again, thereby bringing inconvenience to the user, and thus the market requirements cannot be met. In order to meet the market requirement that switch operations in multiple directions are integrated on one button, a tactical light with a bidirectional switch structure is developed. However, such bidirectional switch structure generally has a complex transmission structure, a large number of parts, high assembling difficulty, and high production cost.

Therefore, there is an urgent need for a bidirectional switch structure and a tactical light which is simple in structure, easy to assemble, and low in production cost.

### BRIEF SUMMARY OF THE INVENTION

In view of the shortcomings in the prior art, it is an object of the present invention to provide a bidirectional switch structure and a tactical light in which lighting control can be achieved by triggering a switch by means of lateral-pressing or down-pressing of a button. The present invention has the advantages of being simple in structure, easy to assemble, and low in production cost.

In order to achieve the above object, the present invention adopts the following technical schemes:

A bidirectional switch structure, comprising:
a base, wherein a switch is arranged on a side surface of the base;
a rotating shaft connected to the side surface of the base, wherein the rotating shaft is rotatable around its own axis;
a button hinged to the rotating shaft, wherein a protruding piece is arranged at an inner side of the button close to the switch; when the button is pressed down, the button rotates around the rotating shaft serving as an axis and presses the switch through the protruding piece; when the button is pressed laterally, the button rotates at a hinged position where the button is hinged to the rotating shaft around an axis perpendicular to the rotating shaft and presses the switch.

Furthermore, a first rotating hole is formed at one end of the rotating shaft which is distant from the base; the first rotating hole is perpendicular to the own axis of the rotating shaft; a bolt is arranged to penetrate through the first rotating hole; the button is rotatably connected to the rotating shaft through the bolt; when the button is pressed laterally, the button rotates around the bolt serving as an axis and presses the switch.

Furthermore, the base comprises a housing and an inner seat mounted in the housing; the switch is mounted on a side surface of the inner seat; the rotating shaft is connected to a side surface of the housing.

Furthermore, a snap ring is disposed on one end of the rotating shaft which penetrates through the housing.

Furthermore, the side surface of the housing is provided with a switch hole corresponding to the switch; a movable part is arranged in the switch hole; the button indirectly presses the switch by pressing the movable part.

Furthermore, the movable part is sleeved with a waterproof ring, and the waterproof ring is in interference fit with an inner wall of the switch hole.

Furthermore, an inclined surface is arranged on one side of the protruding piece; when the button is pressed down, the inclined surface rubs and presses the moving part.

Furthermore, the rotating shaft is connected to a torsion spring to reset the rotating shaft after the rotating shaft rotates around its own axis.

Furthermore, the switch, the button and the rotating shaft are each two in number, and the two switches, the two buttons and the two rotating shafts are symmetrically arranged on opposing side surfaces of the base; each of the switches has a pressing axis which forms an acute angle with the own axis of the corresponding rotating shaft.

The present invention further provides a tactical light which comprises a lighting assembly body and the bidirectional switch structure; the bidirectional switch structure is mounted at a tail end of the lighting assembly body, and the switch is triggered by means of lateral-pressing or down-pressing of the button to control lighting of the lighting assembly body.

The present invention has the following beneficial effects:

According to the present invention, the switch and the rotating shaft are arranged on the base, and the button is hinged to the rotating shaft, so that the switch can be triggered in a lateral-pressing or down-pressing mode; the base comprises the inner seat and the housing, so that the switch can be hidden in the housing to facilitate waterproof design; the rotating shaft can be clamped on the housing by means of the snap ring; the waterproof ring and the movable part are arranged to achieve waterproof effect of the switch; by the arrangement of the inclined surface, transition between the inner side of the button and the top end of the protruding piece is facilitated when the button is pressed down; and by the arrangement of the torsion spring, convenient resetting of the rotating shaft is achieved. The present invention can achieve the lighting control by triggering the switch by means of lateral-pressing or down-pressing of the button, and has the advantages of being simple in structure, easy to assemble, and low in production cost.

### BRIEF DESCRIPTION OF THE DRAWINGS

FIG. 1 is a schematic structural diagram of a bidirectional switch structure according to the present invention;

FIG. 2 is a schematic exploded structural diagram of a bidirectional switch structure according to the present invention;

FIG. 3 is a schematic structural diagram of a button according to the present invention;

FIG. 4 is a schematic exploded structural diagram of a base according to the present invention;

FIG. 5 is a cross-sectional view of a bidirectional switch structure according to the present invention; and

FIG. 6 is a schematic structural diagram of a tactical light according to the present invention.

Numerals in the drawings: 1—base, 110—housing, 111—switch hole, 112—second rotating hole, 120—inner seat; 2—switch; 3—rotating shaft, 310—first rotating hole; 4—button, 410—protruding piece, 411—inclined surface; 5—bolt; 6—snap ring; 7—movable part; 8—waterproof ring; 9—lighting assembly body.

### DETAILED DESCRIPTION OF THE INVENTION

Embodiments of the present invention are described in details below, with preferred examples being illustrated in the accompanying drawings, where the same or similar reference numerals indicate the same or similar elements or elements having the same or similar functions throughout all the drawings. The embodiments described below with reference to the accompanying drawings are exemplary, and are intended to explain the present invention, and should not be construed as a limitation to the present invention.

In the description of the present invention, it should be understood that orientations or positional relationships indicated by the terms “length”, “width”, “upper”, “lower”, “front”, “rear”, “left”, “right”, “vertical”, “horizontal”, “top”, “bottom”, “inner”, “outer”, and the like are orientations or positional relationships as shown in the drawings, and are only for the purpose of facilitating and simplifying the description of the present invention instead of indicating or implying that devices or elements indicated must have particular orientations, or be constructed and operated in the particular orientations. Such terms shall not be construed as limiting the present invention.

In addition, the terms “first” and “second” are only for the purpose of description, and may not be construed as indicating or implying the relative importance or implicitly indicating the number of technical features indicated. Thus, features defined by “first” and “second” may explicitly or implicitly include one or more of that feature. In the description of the present invention, “plurality” refers to two or more, unless otherwise explicitly and specifically defined.

In the embodiments of the present invention, unless otherwise explicitly specified and limited, the terms such as “mount”, “connect”, “link”, “fix” and the like should be interpreted in a broad sense. For example, it may be a fixed connection, a detachable connection or integration; may be a mechanical connection or an electric connection; or may be a direct connection, an indirect connection by means of an intermediate, an internal interconnection of two elements or an interaction of two elements. For those of ordinary skill in the art, the specific meanings of the above terms in the present invention can be construed according to specific situations.

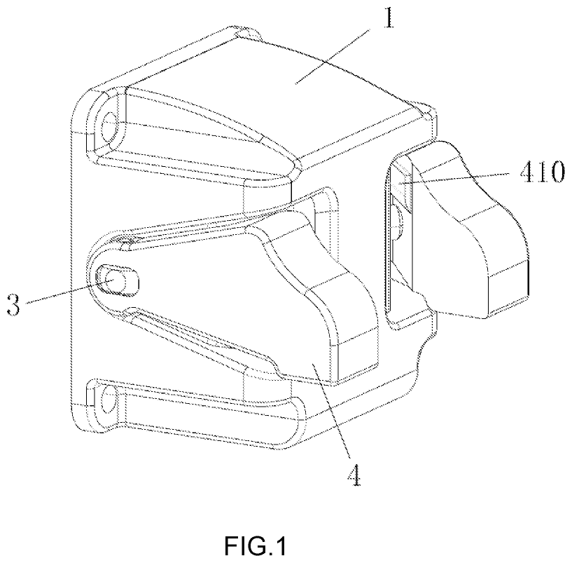

Referring to FIG. 1 to FIG. 6, a specific embodiment of a bidirectional switch structure and a tactical light according to the present invention are shown.

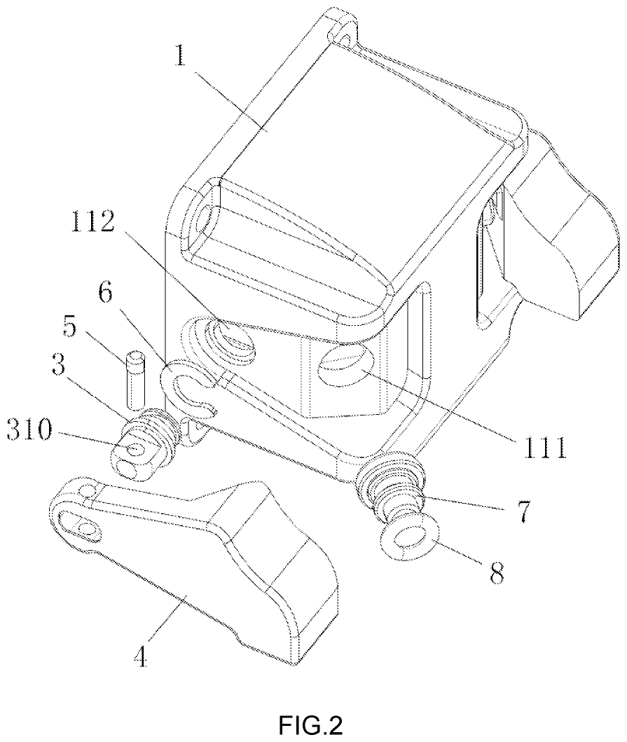

Referring to FIG. 1 and FIG. 2, a bidirectional switch structure comprises:
a base 1, wherein a switch 2 is arranged on a side surface of the base 1;
a rotating shaft 3 connected to the side surface of the base 1, wherein the rotating shaft 3 is rotatable around its own axis;
a button 4 hinged to the rotating shaft 3, wherein a protruding piece 410 is arranged at an inner side of the button 4 close to the switch 2; when the button 4 is pressed down, the button 4 rotates around the rotating shaft 3 serving as an axis and presses the switch 2 through the protruding piece 410; when the button 4 is pressed laterally, the button 4 rotates at a hinged position where the button 4 is hinged to the rotating shaft 3 around an axis perpendicular to the rotating shaft 3 and presses the switch 2.

Referring to FIG. 2, in the above embodiment, the button 4 has a first end which is hinged to the rotating shaft 3 and a second end which is in a free state. The free end is an operation end of the button 4 that can be pressed, and a portion of the rotating shaft 3 extending out of the base 1 is hinged to the button 4. When the button 4 is pressed laterally, the button 4 rotates at the hinged position around the axis perpendicular to the rotating shaft 3 but the rotating shaft 3 does not rotate, and a planar surface on the inner side of the button 4 presses the switch 2 to trigger the switch 2. When the button 4 is pressed down, the rotating shaft 3 is brought to rotate; the free end of the button 4 swings downwards, and the protruding piece 410 located at an upper part of the inner side of the button 4 synchronously moves downwards and pushes the switch 2, thereby triggering the switch 2. In this embodiment, bidirectional rotation of the button 4 is achieved through the rotating shaft 3 and a bolt 5, so that the button 4 has the capabilities of lateral pressing and down pressing.

Referring to FIG. 2, in the above embodiment, a first rotating hole 310 is formed at one end of the rotating shaft 3 which is distant from the base 1; the first rotating hole 310 is perpendicular to the own axis of the rotating shaft 3; the bolt 5 is arranged to penetrate through the first rotating hole 310; the button 4 is rotatably connected to the rotating shaft 3 through the bolt 5; when the button 4 is pressed laterally, the button 4 rotates around the bolt 5 serving as an axis and presses the switch 2. In this embodiment, the button 4 is transversely arranged, and the bolt 5 is longitudinally arranged. When the button 4 is pressed laterally, the button 4 rotates around the bolt 5 serving as an axis, and the planar surface on the inner side of the button 4 presses the switch 2

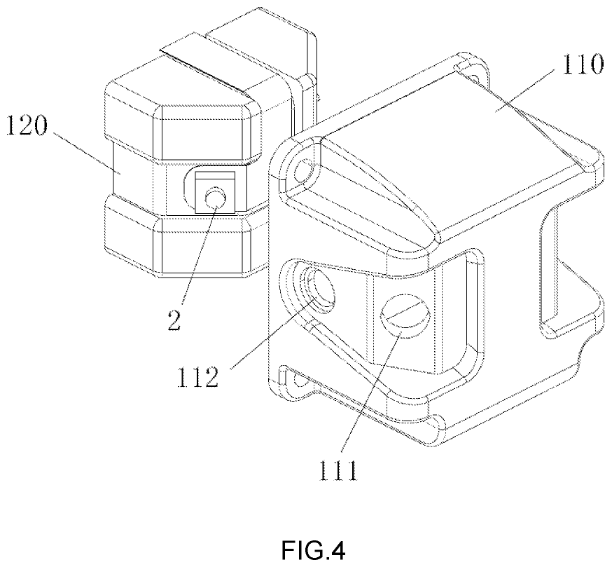

Referring to FIG. 4, in the above embodiment, the base 1 comprises a housing 110 and an inner seat 120 mounted in the housing 110; the switch 2 is mounted on a side surface of the inner seat 120; the rotating shaft 3 is connected to a side surface of the housing 110. In this embodiment, the inner seat 120 is similar to a semi-regular octagon in shape; the rotating shaft 3 and the switch 2 are correspondingly disposed on two adjacent side surfaces respectively; after the button 4 and the rotating shaft 3 are assembled on the housing 110, the inner seat 120 with the switch 2 is mounted in the housing 110, thus completing the assembling of the bidirectional switch structure. The bidirectional switch structure is simple in structure, easy to assemble, and low in production cost.

Referring to FIG. 2, in the above embodiment, a snap ring 6 is disposed on one end of the rotating shaft 3 which penetrates through the housing 110. In the embodiment, a second rotating hole 112 is arranged on a side surface of the housing 110; the rotating shaft 3 is mounted on the second rotating hole 112 from an outer side of the housing 110 and is sleeved with the snap ring 6 from an inner side of the housing 110, so that the rotating shaft 3 and the housing 110 can be relatively fixed. The snap ring 6 is a C-shaped snap ring and is clamped to the rotating shaft 3 from an opening of the snap ring 6, thus achieving the mounting of the snap ring 6. The assembling efficiency is high.

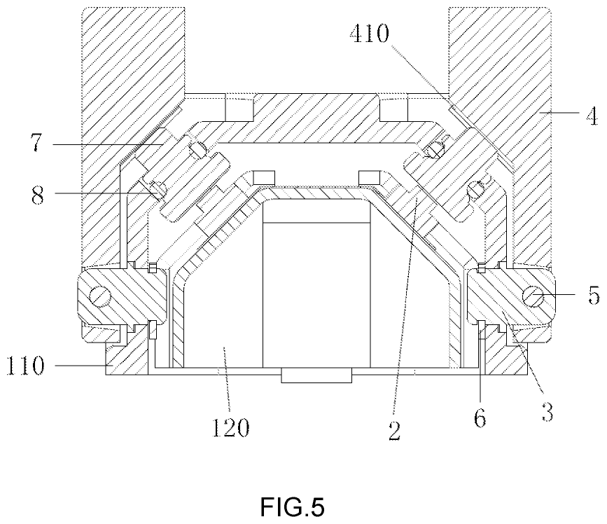

Referring to FIG. 2 and FIG. 5, in the above embodiment, the side surface of the housing 110 is provided with a switch hole 111 corresponding to the switch 2; a movable part 7 is arranged in the switch hole 111; the button 4 indirectly presses the switch 2 by pressing the movable part 7. The movable part 7 is sleeved with a waterproof ring 8, and the waterproof ring 8 is in interference fit with an inner wall of the switch hole 111. In this embodiment, since the movable part 7 is sleeved with the waterproof ring 8, an indirect operation between the button 4 and the switch 2 is achieved, and the switch 2 is dustproof and waterproof and is suitable for use in an outdoor environment.

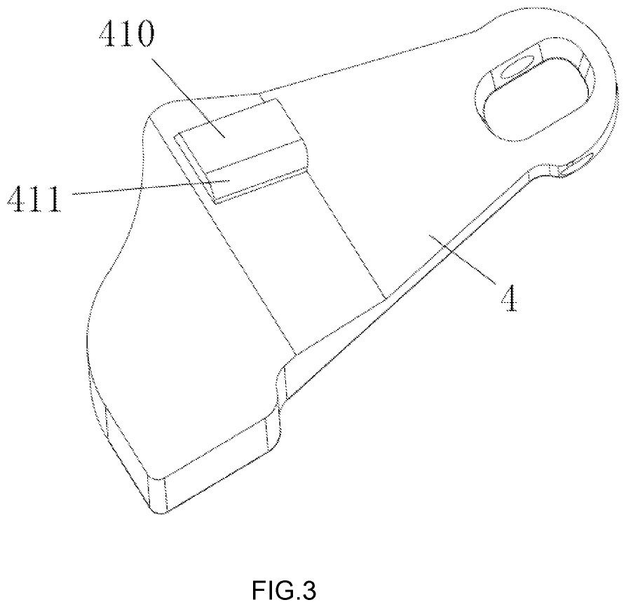

Referring to FIG. 3, in the above embodiment, an inclined surface 411 is arranged on one side of the protruding piece 410. When the button 4 is pressed down, the inclined surface 411 rubs and presses the movable part 7. In this embodiment, the protruding piece 410 is located at an upper part of the movable part 7; the inclined surface 411 is located at a lower part of the protruding piece 410; when the button 4 is pressed down, the protruding piece 410 moves downwards; and in the process when the inclined surface 411 rubs the movable part 7, a force of down pressing is converted into a force of lateral pressing, so that the lateral pressing of the movable part 7 is achieved.

In an optional embodiment, the rotating shaft 3 can be connected to a torsion spring (not shown) to reset the rotating shaft 3 after the rotating shaft 3 rotates around its own axis. In such embodiment, when the rotating shaft 3 is not connected to the torsion spring, and the button 4 is pressed down, a top end of the protruding piece 410 presses the movable part 7 and remains continuously in a pressing state, so as to achieve a long-press effect. After the rotating shaft 3 is connected to the torsion spring, if an external force is released after the button 4 is pressed down to trigger the switch 2, the button 4 will rebound under the action of an elastic force of the torsion spring to achieve a “reset by tapping” effect.

Referring to FIG. 5, in the above embodiment, the switch 2, the button 4 and the rotating shaft 3 are each two in number, and the two switches 2, the two buttons 4 and the two rotating shafts 3 are symmetrically arranged on opposing side surface of the base 1. Each of the switches 2 has a pressing axis which forms an acute angle with the own axis of the corresponding rotating shaft 3. In this embodiment, the buttons 4 arranged on two sides can endow different functions to the switch 2; alternatively, the two buttons 4 are configured with the same function, and the two buttons 4 are simultaneously pressed laterally in a single-hand kneading manner, so that the convenience of operation is improved.

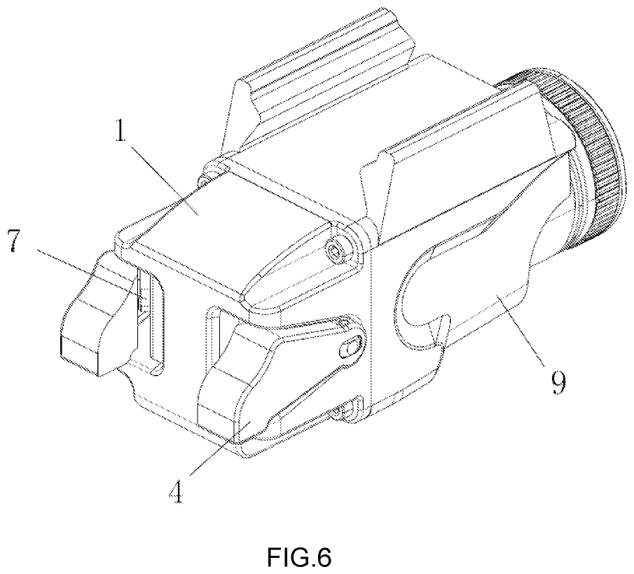

Referring to FIG. 6, this embodiment further provides a tactical light which comprises a lighting assembly body 9 and the above-mentioned bidirectional switch structure. The bidirectional switch structure is mounted at a tail end of the lighting assembly body 9, and the switch 2 is triggered by means of lateral-pressing or down-pressing of the button 4 to control lighting of the lighting assembly body 9.

In summary, this embodiment provides a bidirectional switch structure and a tactical light. The switch 2 and the rotating shaft 3 are arranged on the base 1, and the button 4 is hinged to the rotating shaft 3, so that the switch 2 can be triggered in a lateral-pressing or down-pressing mode; the base 1 comprises the inner seat 120 and the housing 110, so that the switch 2 can be hidden in the housing 110 to facilitate waterproof design; the rotating shaft 3 can be clamped on the housing 110 by means of the snap ring 6; the waterproof ring 8 and the movable part 7 are configured to achieve waterproof effect of the switch 2; by the arrangement of the inclined surface 411, transition between the inner side of the button 4 and the top end of the protruding piece 410 is facilitated when the button 4 is pressed down; and by the arrangement of the torsion spring, convenient resetting of the rotating shaft 3 is achieved. This embodiment can achieve lighting control by triggering the switch by means of lateral-pressing or down-pressing of the button, and has the advantages of being simple in structure, easy to assemble, and low in production cost.

The above-mentioned embodiments are only a part of the preferred specific embodiments of the present invention, and general changes and substitutions by those skilled in the art within the scope of the technical scheme of the present invention shall fall within the protection scope of the present invention.

What is claimed is:

1. A bidirectional switch structure, comprising:
a base, wherein a switch is arranged on a side surface of the base;
a rotating shaft connected to the side surface of the base, wherein the rotating shaft is rotatable around its own axis;
a button hinged to the rotating shaft, wherein a protruding piece is arranged at an inner side of the button close to the switch; when the button is pressed down, the button rotates around the rotating shaft serving as an axis and presses the switch through the protruding piece; when the button is pressed laterally, the button rotates at a hinged position where the button is hinged to the rotating shaft around an axis perpendicular to the rotating shaft and presses the switch.

2. The bidirectional switch structure of claim 1, wherein a first rotating hole is formed at one end of the rotating shaft which is distant from the base; the first rotating hole is perpendicular to the own axis of the rotating shaft; a bolt is arranged to penetrate through the first rotating hole; the button is rotatably connected to the rotating shaft through the bolt; when the button is pressed laterally, the button rotates around the bolt serving as an axis and presses the switch.

3. The bidirectional switch structure of claim 2, wherein the base comprises a housing and an inner seat mounted in the housing; the switch is mounted on a side surface of the inner seat; the rotating shaft is connected to a side surface of the housing.

4. The bidirectional switch structure of claim 3, wherein a snap ring is disposed on one end of the rotating shaft which penetrates through the housing.

5. The bidirectional switch structure of claim 3, wherein the side surface of the housing is provided with a switch hole corresponding to the switch; a movable part is arranged in the switch hole; the button indirectly presses the switch by pressing the movable part.

6. The bidirectional switch structure of claim 5, wherein the movable part is sleeved with a waterproof ring, and the waterproof ring is in interference fit with an inner wall of the switch hole.

7. The bidirectional switch structure of claim 5, wherein an inclined surface is arranged on one side of the protruding piece; when the button is pressed down, the inclined surface rubs and presses the moving part.

8. The bidirectional switch structure of claim 1, wherein the switch, the button and the rotating shaft are each two in number, and the two switches, the two buttons and the two rotating shafts are symmetrically arranged on opposing side surfaces of the base; each of the switches has a pressing axis which forms an acute angle with the own axis of the corresponding rotating shaft.

9. A tactical light, wherein it comprises a lighting assembly body and the bidirectional switch structure as in claim 1; the bidirectional switch structure is mounted at a tail end of the lighting assembly body, and the switch is triggered by means of lateral-pressing or down-pressing of the button to control lighting of the lighting assembly body.
